(19) United States
(12) Patent Application Publication
(10) Pub. No.: US 2013/0262430 A1
(43) Pub. Date: Oct. 3, 2013

(54) DOMINANT IMAGE DETERMINATION FOR SEARCH RESULTS

(71) Applicants: Krishnan Thazhathekalam, Mountain House, CA (US); David D. Ahn, San Francisco, CA (US); Andrea Burbank, Chicago, IL (US); Taroon Mandhana, Redmond, WA (US); David Simpson, San Francisco, CA (US); Yi-An Lin, Sunnyvale, CA (US)

(72) Inventors: Krishnan Thazhathekalam, Mountain House, CA (US); David D. Ahn, San Francisco, CA (US); Andrea Burbank, Chicago, IL (US); Taroon Mandhana, Redmond, WA (US); David Simpson, San Francisco, CA (US); Yi-An Lin, Sunnyvale, CA (US)

(73) Assignee: Microsoft Corporation, Redmond, WA (US)

(21) Appl. No.: 13/434,843

(22) Filed: Mar. 29, 2012

(51) Int. Cl. G06F 17/30

(52) U.S. Cl. 707/711; 707/706; 707/771; 707/722; 707/E17.108; 707/E17.03; 707/E17.002

(57) ABSTRACT

Architecture that computes a dominant image from one or more images on a webpage. A dominant image classifier scans webpages in an offline-created index to identify the prominent images in the webpages. In a more specific implementation the image selected is the image associated with a name query. Face detection technology can be utilized to identify which of the images on a given webpage contain faces. A query classifier identifies queries that contain people names. In the context of search engines and search result pages, the web results for name queries can further include prominent people face images as thumbnail images. Additional facts (structured data) can further be included that together with the results elements of caption title, snippet and attribute (uniform resource locator (URL)) provide an improved summary of the person on the page.

### BACKGROUND

A large number of search queries can be name queries (queries looking for more information about a particular person). A problem with search results for people queries is that the results returned are frequently ambiguous. That is, results are returned for several different people with identical names making it difficult to disambiguate and know which results correspond to the particular person the user wants. This is especially true for queries related to non-famous people.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture computes a dominant image from one or more images on a webpage. A dominant image classifier scans webpages in an offline-created index to identify the prominent images in the webpages. In a more specific implementation the image selected is the image associated with a name query. Face detection technology can be utilized to identify which of the images on a given webpage contain faces. A query classifier identifies queries that contain people names. In the context of search engines and search result pages, the web results for name queries can further include prominent people face images as thumbnail images.

Additional facts (structured data) can further be included that together with the results elements of caption title, snippet and attribute (uniform resource locator (URL)) provide an improved summary of the person on the page. Moreover, the image and structured data improve the user's ability to judge which results belong to which person, and therefore, aid in the role of “informing the click”. The structured data shown can depend on the website of the result and may vary from website to website.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates a system where the dominant image detection and processing is implemented specifically for person images.

FIG. 3 illustrates a diagram where a dominant image is computed and obtained from a related target webpage in accordance with the disclosed architecture.

FIG. 4 illustrates a diagram where an exemplary person search result is obtained from a related target webpage in accordance with the disclosed architecture.

FIG. 5 illustrates logic that enables dominant face image processing in accordance with the disclosed architecture.

FIG. 6 illustrates logic that enables the further introduction of structured data in a search result with the desire image.

FIG. 7 illustrates a method in accordance with the disclosed architecture.

FIG. 8 illustrates further aspects of the method of FIG. 7.

FIG. 9 illustrates an alternative method in accordance with the disclosed architecture.

FIG. 10 illustrates further aspects of the method of FIG. 9.

FIG. 11 illustrates a block diagram of a computing system that executes dominant image computation in accordance with the disclosed architecture.

### DETAILED DESCRIPTION

The disclosed architecture computes a dominant image from one or more images on a webpage. A dominant image classifier scans webpages in an offline-created index to identify the prominent images in the webpages. In a more specific implementation the image selected is the image associated with a name query. Face detection technology can be utilized to identify which of the images on a given webpage contain faces. A query classifier identifies queries that contain people names. In the context of search engines and search result pages, the web results for name queries can further include prominent people face images as thumbnail images. Additional facts (structured data) can further be included that together with the results elements of caption title, snippet and attribute (uniform resource locator (URL)) provide an improved summary of the person on the page.

Examples of structured data include, but are not limited to, data from professional networking websites (e.g., job title, employer, occupation and location), data from social networking and community driven websites (e.g., number of tweets, number of followers, number following, number of questions, number of answers, etc.), and data from profession-specific online resources such as for doctors (e.g., specialty, years of experience, and patient rating, etc.).

People captions assist users by reducing the overall time it takes the user to find the page (or person) sought and improving perceived relevance of the search engine results page (SERP). In cases where the SERP does not present the appropriate results, at least a sufficient amount of information is presented for a successful re-query.

An image is shown in combination with a search result at least insofar where the query is a name query and the underlying webpage includes a prominent image that is a face. Face images (also referred to herein as person images and people images) in search results assist the user by reducing the overall time to perceive relevance of the SERP.

This differs from conventional approaches where an image may be shown with the search result if the webpage belongs to a pre-defined set of well-known websites and also has an image available at a pre-defined location on the page.

Generally, in operation, an image analysis component (e.g., a dominant image classifier) analyzes each webpage for the image metadata as part of an offline process and classifies an image of a webpage as the dominant image for that webpage. As an offline process, dominant images (also referred to a prominent images) within each webpage are computed (determined) in a web search engine index. A webpage may have one or more dominant images or have none. The offline process also uses face detection technology to identify and tag the dominant images within each webpage that contain a face.

Metadata about the dominant images in a webpage is added to each webpage in the index. When a user enters a name query into the search engine, a name query classifier determines if the query contains a person name. For each webpage returned by the search engine for the query, the systems checks to determine if one or more dominant face images are available for the page. If so, one of the face images (chosen by a heuristic such as the dominance score or the confidence in face detection) is chosen to be displayed in thumbnail form as part of the result for the webpage on the search engine results page.

Alternatively, or in combination therewith, when a user enters a query into the search engine, a query classifier computes if the query refers to a type of person and associated context (e.g., a query “actor in the movie Titanic” can also show an image of Leonardo DiCaprio as one of the actors, or additional actors can also be shown). For each webpage returned by the search engine for the query, the systems checks to determine if one or more dominant face images are available for the page. If so, one of the face images (chosen by a heuristic such as the dominance score or the confidence in face detection) is chosen to be displayed in thumbnail form as part of the result for the webpage on the search engine results page.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

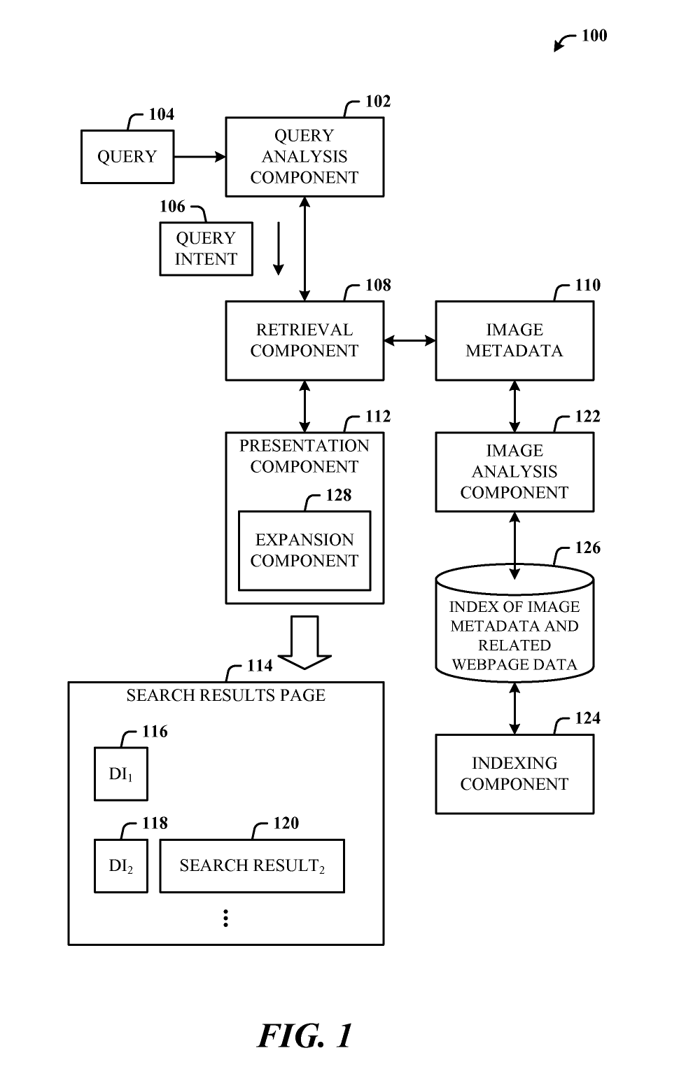

FIG. 1 illustrates a system 100 in accordance with the disclosed architecture. The system 100 can be utilized as part of a search engine framework and includes a query analysis component 102 that performs query analysis on a query 104 and computes (determines) query intent 106 of the query 104. A retrieval component 108 retrieves image metadata 110 (e.g., size, resolution, content, etc.) of dominant images in webpages based on the query analysis. A presentation component 112 presents the dominant images on a search results page 114.

Note that in this specific implementation, dominant image computation and determination is for purposes of query and search processing. However, it is to be understood that dominant image processing can be for the sole purpose of detecting which of multiple images on a webpage is to be considered a dominant image. In the example of FIG. 1, a first dominant image (DI₁) 116 is presented alone on the search results page 114, as associated with a first related target webpage. A second dominant image (DI₂) 118 has been computed and presented in combination with a corresponding search result 120, as associated with a second related target webpage.

The dominant images can be (include) images of individual persons, for example, or any image as determined dominant for that associated webpage. The dominant images (e.g., image 118) can be presented as thumbnail images proximate the corresponding search results. The dominant image is a single image obtained from the associated webpage.

The system 100 can further comprise an image analysis component 122 that analyzes each webpage for image metadata (e.g., image metadata 110) as part of an offline process and classifies an image of a webpage as the dominant image for that webpage.

The system 100 can further comprise an indexing component 124 that creates an index 126 of the image metadata and an associated search result (related webpage data) as an offline process. The image analysis component 122 further analyzes each webpage for structured data that is presented with the corresponding dominant image and search result. At least one of the image or the structured data can be retrieved (or received) from the associated webpage or an off-page resource. The presentation component 112 further comprises an expansion component 128 that presents additional information proximate the corresponding result in response to a user action.

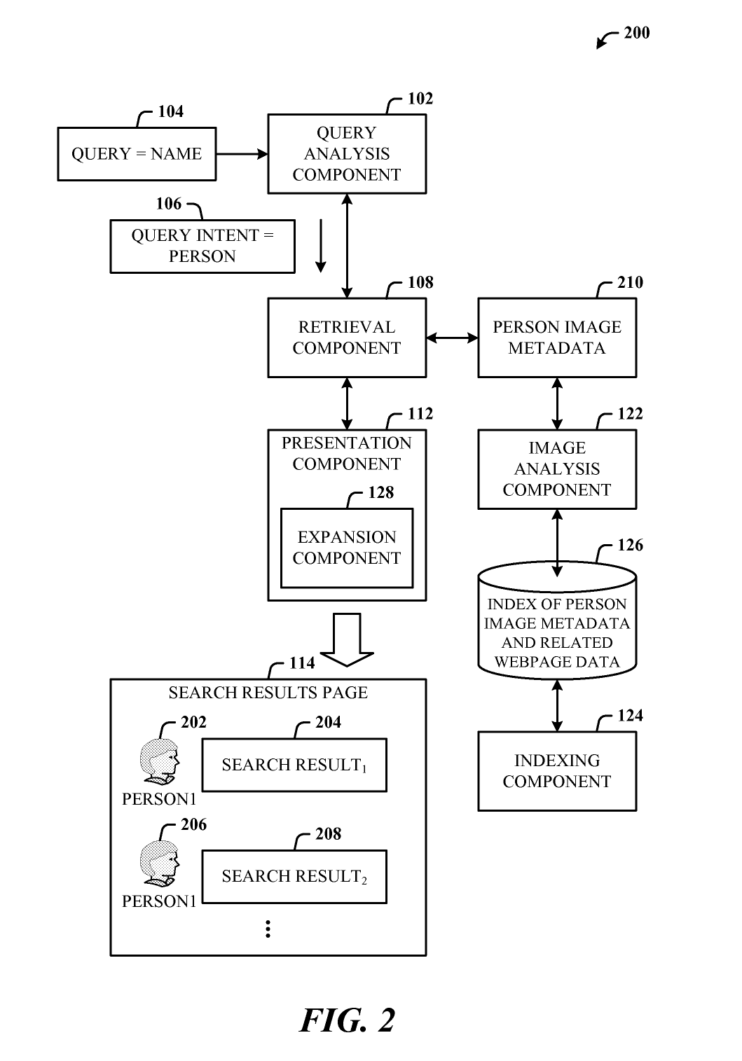

FIG. 2 illustrates a system 200 where the dominant image detection and processing is implemented specifically for person images. As before, the system 200 can be utilized as part of a search engine framework and includes the query analysis component 102 to perform query analysis on the query 104 (a name query) and compute (determine) the query intent 106 of the query 104 to be related to a specific person. The retrieval component 108 retrieves person image metadata (the image metadata 110) of dominant person images in webpages based on the query analysis. The presentation component 112 presents the dominant person images on the search results page 114.

In this implementation, a first dominant person image 202 (e.g., the first dominant image 116 of FIG. 1) is a person image (e.g., a face image) presented in combination with a search result 204 on the search results page 114, as associated with a first related target webpage. A second dominant person image 206 (e.g., the second dominant image 118 of FIG. 1) has been computed and presented in combination with a corresponding search result 208, as associated with a second related target webpage. Since the query is a specific name of a person, the user intent may be to obtain information only about that specific user. Thus, it is possible that the person images returned from associated, but different, webpages may be the same image or different images of the same person. The dominant person images (e.g., image 118 of FIG. 1) can be presented as thumbnail images proximate the corresponding search results.

The system 200 can further comprise the image analysis component 122 that analyzes each webpage for person image metadata 210 (e.g., as part of the image metadata 110 of FIG. 1) as part of an offline process and classifies a person image of a webpage as the dominant person image for that webpage, and more specifically, for the specific person of the intended query.

The system 200 can further comprise the indexing component 124 that creates the index 126 of person image metadata and an associated search result (related webpage data) as an offline process. The image analysis component 122 can further analyze each target webpage for structured data that is presented with the corresponding dominant image and search result. At least one of the person image or the structured data can be retrieved (or received) from the associated webpage or an off-page resource. The presentation component 112 can further comprise the expansion component 128 that presents additional information proximate the corresponding result in response to a user action (e.g., hover, mouse-over, etc.).

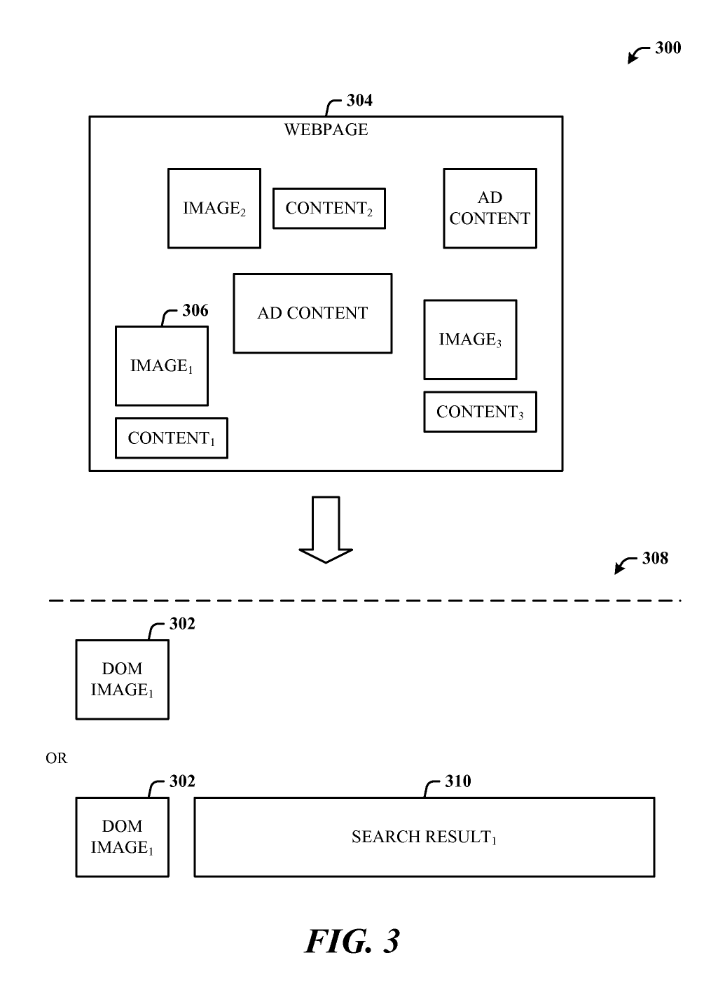

FIG. 3 illustrates a diagram 300 where a dominant image 302 is computed and obtained from a related target webpage 304 in accordance with the disclosed architecture. In this example, the query intent is determined to be related to an image. For example, the query may contain a term or terms (e.g., picture, shot, image, photo, pic, etc.) that infer an image is desired by the searching user. In this example, there are three images on the webpage 304. The disclosed architecture computes (e.g., through image analysis separately, or in combination with content analysis proximate the image) that the one of the images, image 306 (IMAGE₁), is the dominant image 302. The dominant image 306 can be presented separately on the results page 308 in association with a search result 310.

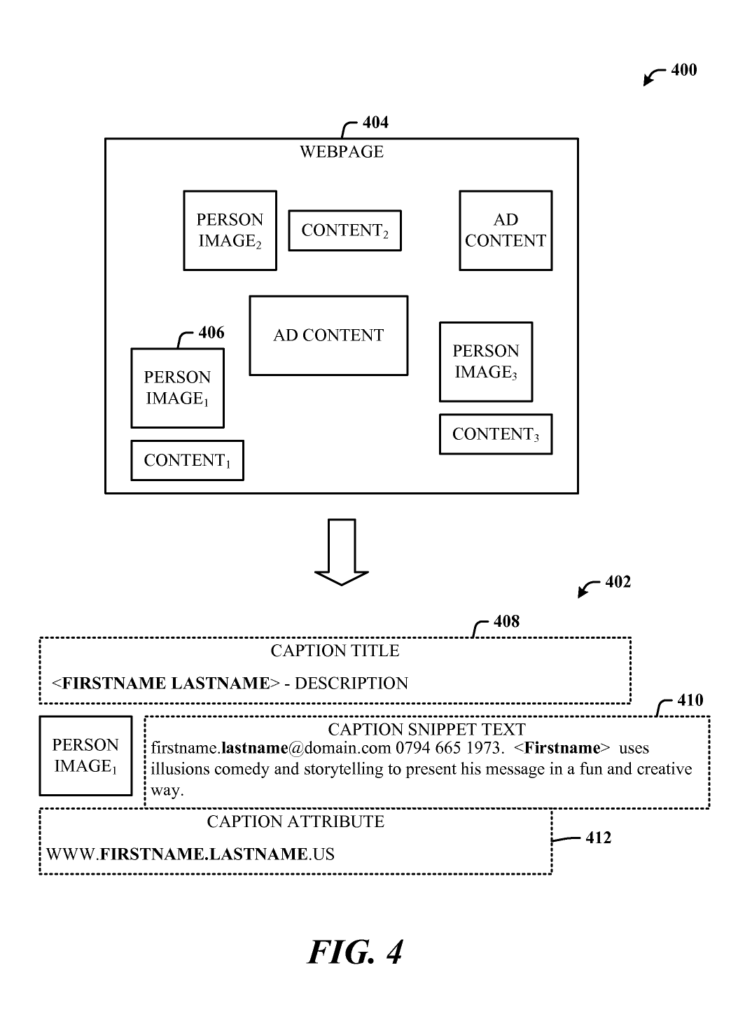

FIG. 4 illustrates a diagram 400 where an exemplary person search result 402 is obtained from a related target webpage 404 in accordance with the disclosed architecture. In this example, the query intent is determined to be a name query that is associated with a user name FIRSTNAME LASTNAME. There are three person images on the webpage 404; however, the architecture computes (e.g., through image analysis separately, or in combination with content analysis proximate the image) that the desired image is person image 406 (PERSON IMAGE₁), as is associated with the name query. Accordingly, the person image 406 is presented as part of the search result 402, along with the caption (caption title 408, caption snippet 410, and caption attribute 412). Additionally, terms in the query can be visually emphasized (e.g., bolded) in the search result, the terms include the firstname and lastname of the person.

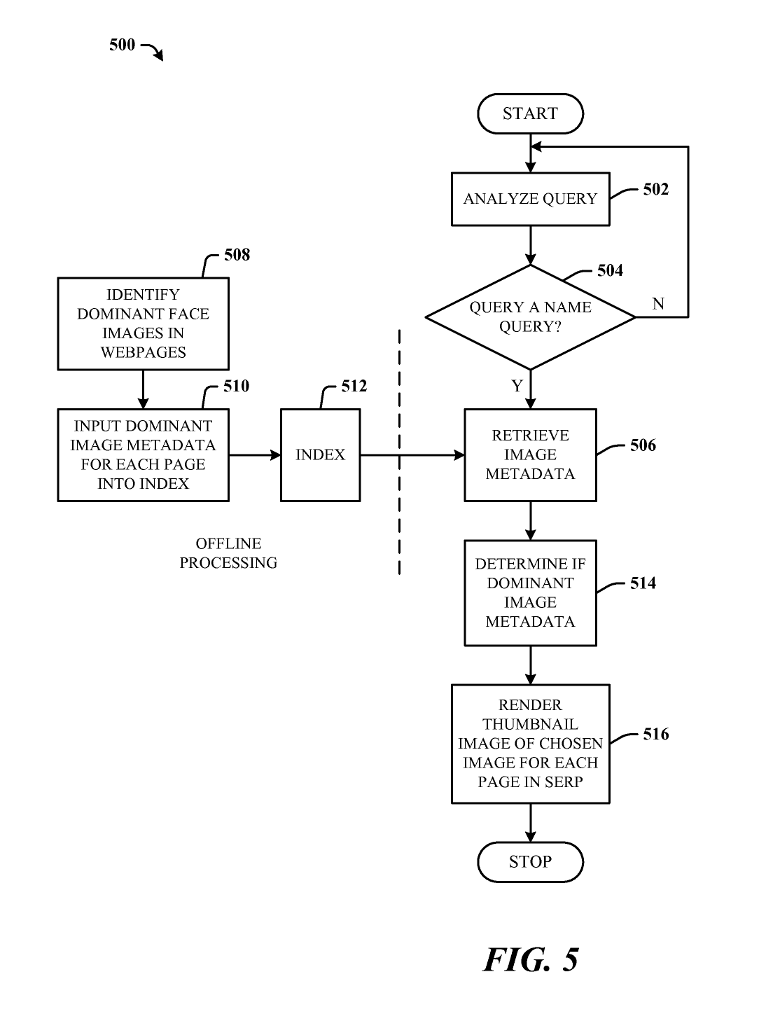

FIG. 5 illustrates logic 500 that enables dominant face image processing in accordance with the disclosed architecture. At 502, the query is analyzed for a name query. At 504, if the query is not a name query, flow returns to 502. If the query is a name query, flow is from 504 to 506, to retrieve image metadata. In an offline process, the image metadata is derived beforehand. Accordingly, at 508, dominant face images in the offline store of webpages, are identified and analyzed for image metadata. At 510, the dominant image metadata for each webpage is input into an index (using the indexing component). At 512, the index is made available so that the image metadata can be extracted for caption generation in the search result.

Once the image metadata is obtained, at 506, flow is to 514, where a dominant face image is determined based on the image metadata. Where there are multiple images, additional heuristics can be employed, if necessary. At 516, the dominant image chosen can be rendered on the result page as a thumbnail image proximate the associated search result on the search engine results page (SERP) for each webpage.

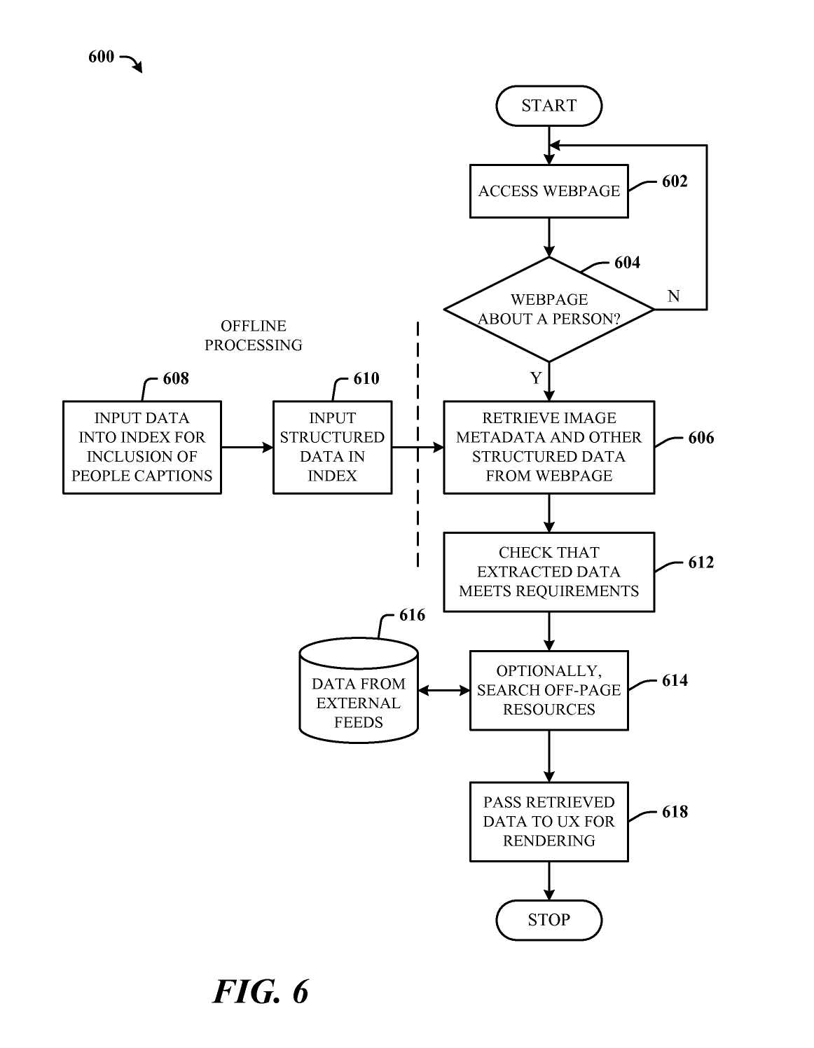

FIG. 6 illustrates logic 600 that enables the further introduction of structured data in a search result with the desire image. At 602, a webpage is accessed. At 604, a check is made as to if the webpage is about a person (e.g., is the webpage associated with a people site or otherwise identified as being about a person). At 606, image metadata and other structured data is retrieved form the webpage. In order to support this retrieval, offline processing includes the following. At 608, an index is created and receives as input data for the inclusion of people captions (part of the search result). At 610, the structured data is added to the index. The index is then exposed (made accessible) to the process at 606. At 612, the data (metadata and structured) is checked to ensure that it meets the configured requirements (e.g., image is not unacceptable content, meets minimum dimensional measurements such as height and width, etc.). At 614, off-page resources (external feeds) can be accessed, optionally, for data 616. At 618, the retrieved data is then passed to the user experience (UX) for rendering.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

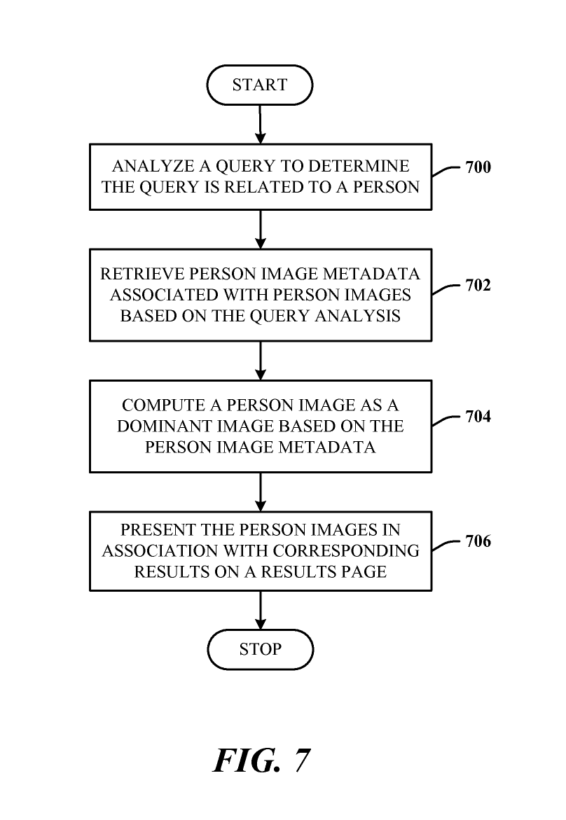

FIG. 7 illustrates a method in accordance with the disclosed architecture. At 700, a query is analyzed to determine if the query is related to a person. At 702, person image metadata associated with person images is retrieved based on the query analysis. At 704, a person image is computed as a dominant image based on the person image metadata. At 706, the person images are presented in association with corresponding results on a results page.

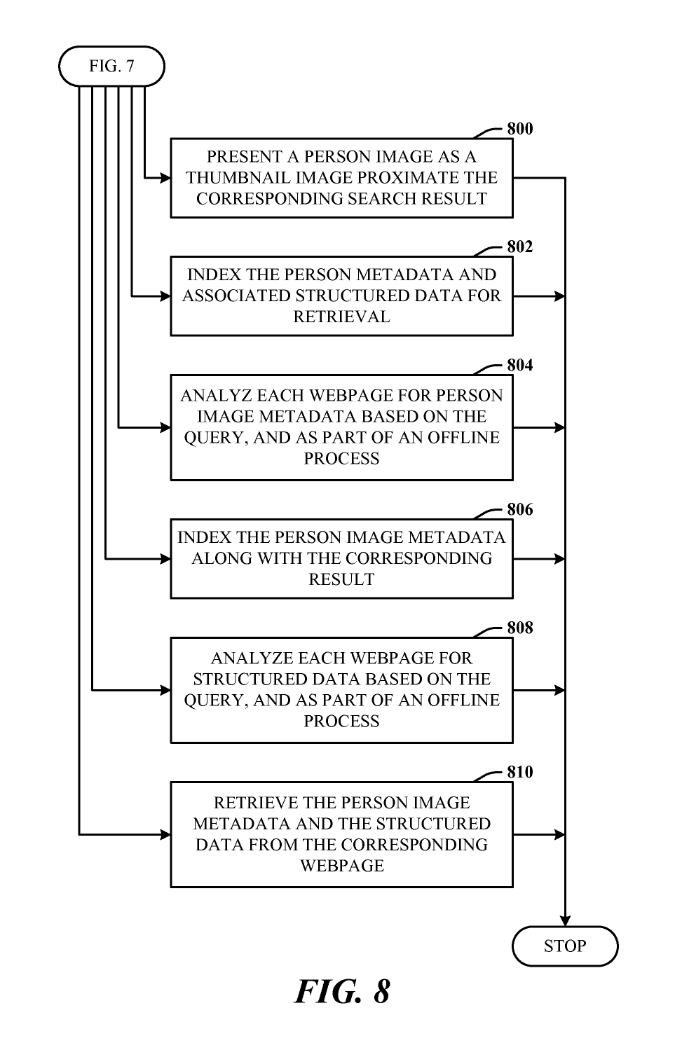

FIG. 8 illustrates further aspects of the method of FIG. 7. Note that the flow indicates that each block can represent a step that can be included, separately or in combination with other blocks, as additional aspects of the method represented by the flow chart of FIG. 7. At 800, a person image is presented as a thumbnail image proximate the corresponding search result. At 802, the person metadata and associated structured data are indexed for retrieval. At 804, each webpage is analyzed for person image metadata based on the query, and as part of an offline process. At 806, the person image metadata is indexed along with the corresponding result. At 808, each webpage is analyzed for structured data based on the query, and as part of an offline process. At 810, the person image metadata and the structured data are retrieved from the corresponding webpage.

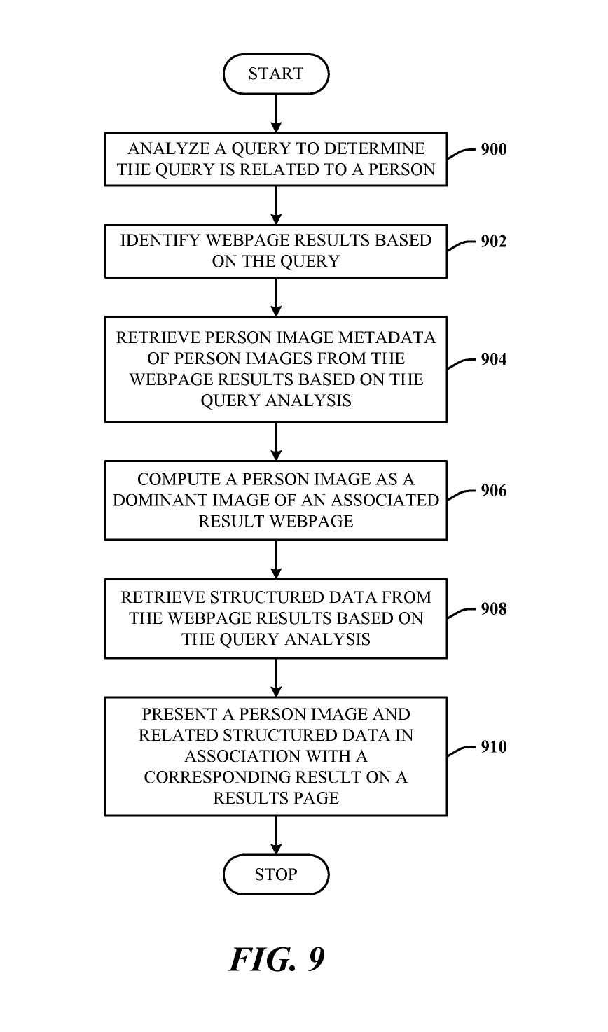

FIG. 9 illustrates an alternative method in accordance with the disclosed architecture. At 900, a query is analyzed to determine the query is related to a person. At 902, webpage results are analyzed based on the query. At 904, person image metadata of person images is retrieved from the webpage results based on the query analysis. At 906, a person image is computed as a dominant image of an associated result webpage. At 908, structured data is retrieved from the webpage results based on the query analysis. At 910, a person image and related structured data are presented in association with a corresponding result on a results page.

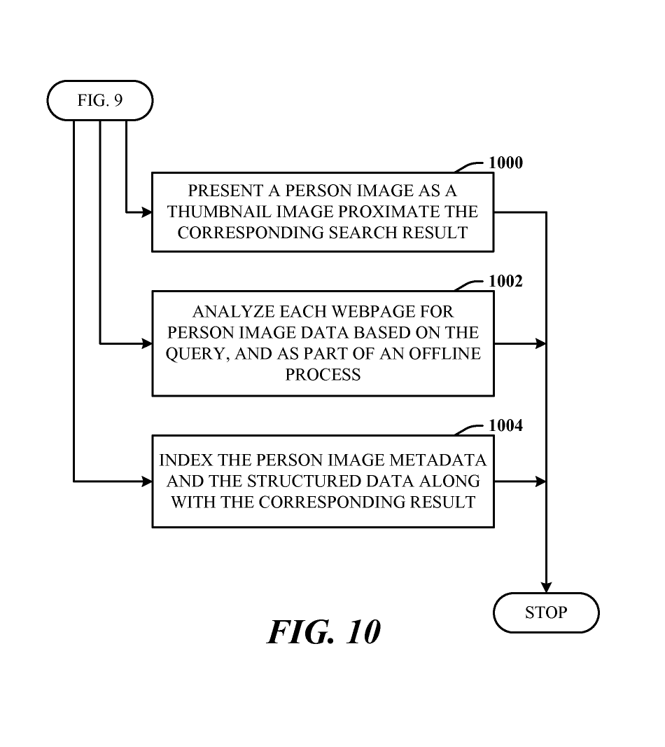

FIG. 10 illustrates further aspects of the method of FIG. 9. Note that the flow indicates that each block can represent a step that can be included, separately or in combination with other blocks, as additional aspects of the method represented by the flow chart of FIG. 9. At 1000, a person image is presented as a thumbnail image proximate the corresponding search result. At 1002, each webpage is analyzed for person image data based on the query, and as part of an offline process. At 1004, the person image metadata and the structured data are indexed along with the corresponding result.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

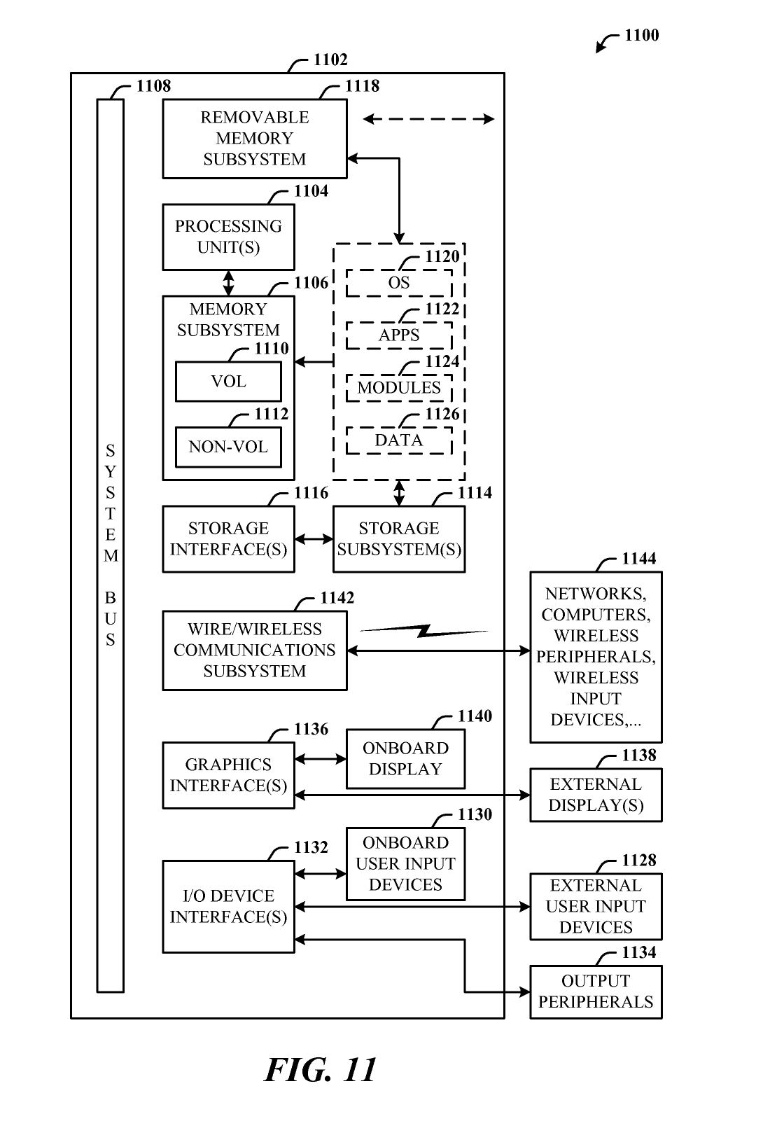

Referring now to FIG. 11, there is illustrated a block diagram of a computing system 1100 that executes dominant image computation in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 11 and the following description are intended to provide a brief, general description of the suitable computing system 1100 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1100 for implementing various aspects includes the computer 1102 having processing unit(s) 1104, a computer-readable storage such as a system memory 1106, and a system bus 1108. The processing unit(s) 1104 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1106 can include computer-readable storage (physical storage media) such as a volatile (VOL) memory 1110 (e.g., random access memory (RAM)) and non-volatile memory (NON-VOL) 1112 (e.g., ROM, EPROM, EEPROM, etc.). A basic input/output system (BIOS) can be stored in the non-volatile memory 1112, and includes the basic routines that facilitate the communication of data and signals between components within the computer 1102, such as during startup. The volatile memory 1110 can also include a high-speed RAM such as static RAM for caching data.

The system bus 1108 provides an interface for system components including, but not limited to, the system memory 1106 to the processing unit(s) 1104. The system bus 1108 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1102 further includes machine readable storage subsystem(s) 1114 and storage interface(s) 1116 for interfacing the storage subsystem(s) 1114 to the system bus 1108 and other desired computer components. The storage subsystem(s) 1114 (physical storage media) can include one or more of a hard disk drive (HDD), a magnetic floppy disk drive (FDD), solid state drive (SSD), and/or optical disk storage drive (e.g., a CD-ROM drive DVD drive), for example. The storage interface(s) 1116 can include interface technologies such as EIDE, ATA, SATA, and IEEE 1394, for example.

One or more programs and data can be stored in the memory subsystem 1106, a machine readable and removable memory subsystem 1118 (e.g., flash drive form factor technology), and/or the storage subsystem(s) 1114 (e.g., optical, magnetic, solid state), including an operating system 1120, one or more application programs 1122, other program modules 1124, and program data 1126.

The operating system 1120, one or more application programs 1122, other program modules 1124, and/or program data 1126 can include entities and components of the system 100 of FIG. 1, entities and components of the system 200 of FIG. 2, entities and flow of the diagram 300 of FIG. 3, entities and flow of the diagram 400 of FIG. 4, entities and components of the logic 500 of FIG. 5, entities and components of the logic 600 of FIG. 6, and the methods represented by the flowcharts of FIGS. 7-10, for example.

Generally, programs include routines, methods, data structures, other software components, etc., that perform particular tasks or implement particular abstract data types. All or portions of the operating system 1120, applications 1122, modules 1124, and/or data 1126 can also be cached in memory such as the volatile memory 1110, for example. It is to be appreciated that the disclosed architecture can be implemented with various commercially available operating systems or combinations of operating systems (e.g., as virtual machines).

The storage subsystem(s) 1114 and memory subsystems (1106 and 1118) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 1102 and includes volatile and non-volatile internal and/or external media that is removable or non-removable. For the computer 1102, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 1102, programs, and data using external user input devices 1128 such as a keyboard and a mouse. Other external user input devices 1128 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1102, programs, and data using onboard user input devices 1130 such a touchpad, microphone, keyboard, etc., where the computer 1102 is a portable computer, for example.

These and other input devices are connected to the processing unit(s) 1104 through input/output (I/O) device interface(s) 1132 via the system bus 1108, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1132 also facilitate the use of output peripherals 1134 such as printers, audio devices, camera devices, and so on, such as a sound card and/or onboard audio processing capability.

One or more graphics interface(s) 1136 (also commonly referred to as a graphics processing unit (GPU)) provide graphics and video signals between the computer 1102 and external display(s) 1138 (e.g., LCD, plasma) and/or onboard displays 1140 (e.g., for portable computer). The graphics interface(s) 1136 can also be manufactured as part of the computer system board.

The computer 1102 can operate in a networked environment (e.g., IP-based) using logical connections via a wired/wireless communications subsystem 1142 to one or more networks and/or other computers. The other computers can include workstations, servers, routers, personal computers, microprocessor-based entertainment appliances, peer devices or other common network nodes, and typically include many or all of the elements described relative to the computer 1102. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1102 connects to the network via a wired/wireless communication subsystem 1142 (e.g., a network interface adapter, onboard transceiver subsystem, etc.) to communicate with wired/wireless networks, wired/wireless printers, wired/wireless input devices 1144, and so on. The computer 1102 can include a modem or other means for establishing communications over the network. In a networked environment, programs and data relative to the computer 1102 can be stored in the remote memory/storage device, as is associated with a distributed system. It will be appreciated that the network connections shown are exemplary and other means of establishing a communications link between the computers can be used.

The computer 1102 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system, comprising:
a query analysis component of a search engine framework that performs query analysis on a query and determines query intent of the query;
a retrieval component that retrieves image metadata of dominant images in webpages based on the query analysis;
a presentation component that presents the dominant images on a search results page, at least one of the dominant images being presented without a corresponding query result; and
a microprocessor that executes computer-executable instructions in memory.

2. The system of claim 1, wherein the dominant images include images of individual persons.

3. The system of claim 1, wherein each dominant image presented with a corresponding query result is presented as a thumbnail image proximate to the corresponding search result.

4. The system of claim 1, wherein each dominant image is a single image obtained from the associated webpage.

5. The system of claim 1, further comprising an image analysis component that analyzes each webpage for the image metadata as part of an offline process and classifies an image of a webpage as the dominant image for that webpage.

6. The system of claim 5, further comprising an indexing component that creates an index of the image metadata and an associated search result as an offline process.

7. The system of claim 5, wherein the image analysis component further analyzes each webpage for structured data that is presented with the corresponding dominant image and search result.

8. The system of claim 7, wherein at least one of the image or the structured data is retrieved from the associated webpage or an off-page resource.

9. The system of claim 1, wherein the presentation component further comprises an expansion component that presents additional information proximate a corresponding result in response to a user action.

10. A method, comprising acts of:
analyzing a query to determine the query is related to a person;
retrieving person image metadata associated with person images based on the query analysis;
computing person images as a dominant image based on the person image metadata;
presenting the person images in association with corresponding results on a results page, at least one of the person images being presented without a corresponding query result while at least another one of the person images is presented with a corresponding query result; and
utilizing a microprocessor to execute instructions stored in memory.

11. The method of claim 10, further comprising presenting each person image presented with a corresponding search result as a thumbnail image proximate the corresponding search result.

12. The method of claim 10, further comprising indexing the person metadata and associated structured data for retrieval.

13. The method of claim 10, further comprising analyzing each webpage for person image metadata based on the query, and as part of an offline process.

14. The method of claim 10, further comprising indexing the person image metadata along with the corresponding result.

15. The method of claim 10, further comprising analyzing each webpage for structured data based on the query, and as part of an offline process.

16. The method of claim 10, further comprising retrieving the person image metadata and the structured data from the corresponding webpage.

17. A method, comprising acts of:
analyzing a query to determine the query is related to a person;
identifying webpage results based on the query;
retrieving person image metadata of person images from the webpage results based on the query analysis;
computing a person image as a dominant image of an associated result webpage;
retrieving structured data from the webpage results based on the query analysis;
presenting a person image and related structured data in association with a corresponding result on a results page; and
utilizing a microprocessor to execute instructions stored in memory.

18. The method of claim 17, further comprising presenting a person image as a thumbnail image proximate the corresponding search result.

19. The method of claim 17, further comprising analyzing each webpage for person image data based on the query, and as part of an offline process.

20. A method, comprising:
identifying webpage results based on a query, when a query analysis determines that a query is related to a person;
retrieving person image meta data of person images from the webpage results, based on the query analysis;
determining that a person image is a dominant image of an associated webpage;
retrieving structure data from the webpage results, based on the query analysis; and
presenting a person image and related structured data in association with a corresponding result on a results page, the result including a caption that includes a caption attribute, the caption attribute visually emphasizing terms of the query.
